(19) United States
(12) Patent Application Publication
(10) Pub. No.: US 2005/0268174 A1
(43) Pub. Date: Dec. 1, 2005

(54) Semiconductor device, electronic apparatus, and access control method of the semiconductor device

(76) Inventor: Tomonori Kumagai, Sapporo (JP)

Correspondence Address: HARNESS, DICKEY & PIERCE, P.L.C., P.O. BOX 828, BLOOMFIELD HILLS, MI, 48303, US

(21) Appl. No.: 11/108,991

(22) Filed: Apr. 19, 2005

(30) Foreign Application Priority Data
Apr. 21, 2004 (JP) 2004-125735

(51) Int. Cl. G06F 11/00

(52) U.S. Cl. 714/38

(57) ABSTRACT

The semiconductor device comprises a memory for storing access data of a central processing unit, a security circuit for restricting access to the memory from one of the central processing unit and a debugger having an emulation function of the central processing unit and for accessing the memory as a substitute of the central processing unit, and a debug-enable signal input terminal. When the debug-enable signal is inactive, an access signal from the debugger to the semiconductor device is invalidated, and the security circuit enables the central processing unit to access the memory. When the debug-enable signal is active, the access signal becomes valid, and the security circuit disables access to the memory. After then, when a password for access is input from the debugger, the security circuit enables the debugger to access the memory.

### RELATED APPLICATIONS

This application claims priority to Japanese Patent Application No. 2004-125735 filed Apr. 21, 2004 which is hereby expressly incorporated by reference herein in its entirety.

### BACKGROUND

1. Technical Field

The present invention relates to a semiconductor device, an electronic apparatus, and an access method of the semiconductor device.

2. Related Art

In some cases, data necessary to be kept strictly confidential may be stored in a memory implemented in a semiconductor device. In particular, in a semiconductor device equipped with a central processing unit (CPU) and a memory storing source codes which are access data of the CPU, the data necessary to be kept strictly confidential may sometimes be included in the source codes. In such a case, it is necessary to prevent illegally accessing the memory by a debugger used to develop a system using the semiconductor device. Therefore, some security measures must be taken considering the debugging environment.

While taking some security measures considering the debugging environment of the semiconductor device, as described above, it is also necessary to prevent the cost of the semiconductor device or the developing cost of the system implementing the semiconductor device from increasing.

The technology disclosed in Japanese Unexamined Patent Publication No. 2003-177938, however, which requires an additional external device, incurs a higher cost of the developing environment. Further, since software for realizing security functions must be implemented in the semiconductor device, the communication control with external devices is made complicated. Moreover, an additional security measure is required such as separately storing data for realizing the security function and data to be kept strictly confidential in the semiconductor device, which problematically complicates the configuration and control of the semiconductor device.

The present invention is made in view of the technical problem described above, and addresses to realize a security function with low cost, thus providing a semiconductor device capable of being debugged with a general-purpose debugger, an electronic apparatus, and a access control method of the semiconductor device.

### SUMMARY

In order to solve the above problem, the present invention relates to a semiconductor device comprising: a central processing unit; a main memory accessed by the central processing unit; a security circuit for restricting one of access to the main memory from the central processing unit and access to the main memory from a debugger having an emulation function of the central processing unit and for accessing the main memory as a substitute of the central processing unit; and a debug-enable signal input terminal to which a debug-enable signal for enabling a debugging function of the debugger is input, wherein, when the debug-enable signal is inactive, an access signal from the debugger to the semiconductor device is invalidated, and the security circuit enables the central processing unit to access the main memory, when the debug-enable signal is active, the access signal from the debugger to the semiconductor device is validated, and the security circuit enables the debugger to access the main memory.

According to the present invention, since the debug-enable signal input terminal is provided, whether or not a general purpose debugger is connected thereto can be detected without providing any additional circuits to the debugger or the like. Further, it is arranged that the debugging function is enabled by the debug-enable signal, and in the enabled state, the access signal from the debugger to the semiconductor device is validated, further, the security circuit detects connection of the debugger to temporally disable access to the main memory. After then, if input data expressed by at least a part of the access signal is predetermined data, the security circuit enables the debugger to access the main memory Thus, since a general purpose debugger can be used, and illegal access to the memory from the general purpose debugger can be restricted with a simple configuration, system development cost can be reduced.

Further, in the semiconductor device according to the present invention, when the debug-enable signal is active, the access signal from the debugger to the semiconductor device is validated, after the security circuit disables the access to the main memory, if input data expressed by at least a part of the access signal is predetermined data, the security circuit enables the debugger to access the main memory.

Further, the semiconductor device according to the present invention, further comprises: a secret unique data storing section to which secret unique data is previously set; and an encryption password generating section for generating encryption password data based on the secret unique data and the input data, wherein, when password data for verification set previously matches with the encryption password data, the security circuit enables the debugger to access the main memory.

Further, in the semiconductor device according to the present invention, the encryption password generating section generates the encryption password data with a one-way encryption process based on the secret unique data and the input data.

According to the present invention, since the one-way encryption process is used as the encryption process described above, the encryption key can be eliminated thus maintaining the security with a simple configuration.

Further, according to the present invention, the encryption password is generated by the one-way encryption process using the secret unique data and the input data, the input data can be changed for each user without any speculation about the relationship between the input data and the password for verification.

Further, in the semiconductor device according to the present invention, when the debugger is disabled to access the main memory, if the semiconductor device is hardware-reset, then a succeeding access signal from the debugger is received.

In the present invention, when the access from the debugger is judged illegal, the succeeding access signal, namely the succeeding input data is not received unless the semiconductor device is hardware-reset. Accordingly, since the attack with a series of data of continuous values using illegal dedicated software can be prevented, the number of bit of the input data can be saved as much.

Further, the semiconductor device according to the present invention, comprises a decryption key data storing section for storing decryption key data; and a decryption processing section for executing a decryption process, using the decryption key data, on a source code retrieved from a nonvolatile memory and written into the main memory, wherein, when the security circuit enables access to the main memory, one of the central processing unit and the debugger retrieves the decrypted source code of the decryption processing section.

Further, the semiconductor device according to the present invention, comprises: a decryption key unique data storing section to which decryption key unique data is previously set, wherein, the decryption key data is generated based on data for decryption set previously and the decryption key unique data, and then the decryption key data is stored in the decryption key data storing section.

In the present invention, since the decrypted data is developed in the memory after the access from the debugger is proper, the security against the illegal access from the debugger can further be enhanced.

Further, in the semiconductor device according to the present invention, when the security circuit enables one of the debugger and the central processing unit to access the main memory, the security circuit releases masking of the access signals output by one of the debugger and the central processing unit, and when the security circuit disables one of the debugger and the central processing unit to access the main memory, the security circuit masks the access signals output by one of the debugger and the central processing unit.

According to the present invention, the security circuit can be realized with a simple configuration.

The semiconductor device according to the present invention as described above, development with a general purpose debugger becomes possible, and reverse engineering in which the data in the main memory is analyzed by illegal access from the debugger can be prevented to surely protect licensed highly confidential information.

Further, the present invention relates to an electronic apparatus comprising the semiconductor device described above, a general purpose serial bus interface, wherein, in the semiconductor device, after the source code stored in the nonvolatile memory is transferred to and stored in the main memory, the central processing unit executes process of data transferred via the general purpose serial bus interface in accordance with the source code stored in the main memory.

According to the present invention, an electronic apparatus including a semiconductor device capable of being developed with a general purpose debugger, and preventing reverse engineering in which the data in the main memory is analyzed by illegal access from the debugger, and surely protecting licensed highly confidential information can be provided.

Further, the present invention relates to an access control method of the semiconductor device in which a source code accessed by the central processing unit is stored in the main memory, comprising the steps of invalidating an access signal from a debugger to the semiconductor device and enabling the central processing unit to access the main memory when a debug-enable signal is inactive, the debug-enable signal enabling a debugging function of the debugger which has an emulation function of the central processing unit and accesses the main memory as a substitute of the central processing unit; and validating the access signal from the debugger to the semiconductor device and enabling the debugger to access the main memory when the debug-enable signal is active.

Further, in the access control method of the semiconductor device according to the present invention, in the step of enabling the debugger to access the main memory, after the security circuit disables the access to the main memory, if input data expressed by at least a part of the access signal is predetermined data, the debugger can be enabled to access the main memory.

Further, the access control method of the semiconductor device according to the present invention, further comprises the step of: generating encryption password data based on the secret unique data set previously and the input data, wherein, when password data for verification set previously matches with the encryption password data, the security circuit enables the debugger to access the main memory.

Further, in the access control method of the semiconductor device according to the present invention, when the debugger is disabled to access the main memory, if the semiconductor device is hardware-reset, a succeeding access signal from the debugger is received.

### BRIEF DESCRIPTION OF THE DRAWINGS

FIG. 1 is a configuration chart showing a principle configuration of a semiconductor device according to the present embodiment.

FIG. 2 is a circuit diagram of a configuration example of a mask circuit.

FIG. 3 is a circuit diagram of another configuration example of a mask circuit.

FIG. 4 is a circuit diagram of still another configuration example of a mask circuit.

FIG. 5 is a block diagram of a detailed configuration example of a semiconductor device according to the present embodiment and of a configuration example of a system using the semiconductor device.

FIG. 6 is a block diagram of a configuration example of an access control section.

FIG. 7 is a view for showing a description example of a hardware description language for explaining the operation of a comparing section.

FIG. 8 is a view for showing a configuration example of a functional block diagram of an external system.

FIG. 9 is a view for showing an example of a flowchart corresponding to a writing process of password data for verification executed by the external system shown in FIG. 8.

FIG. 10 is a view for showing an example of a flowchart corresponding to a writing process of a source code executed by the external system shown in FIG. 8.

FIG. 11 is a view for showing an example of an operational sequence of the system shown in FIG. 5.

FIG. 12 is a view for showing another example of an operational sequence of the system shown in FIG. 5.

FIG. 13 is a block diagram of a configuration example of a data transfer control device applying the semiconductor device according to the present embodiment.

FIG. 14 is an example of a block diagram of electronic equipment including the data transfer control device shown in FIG. 13.

FIG. 15 is a schematic view for showing an example of an outside view of the electronic equipment shown in FIG. 14.

### DETAILED DESCRIPTION

Hereinafter, an embodiment of the present invention is described in detail with reference to the accompanying drawings. Note that the embodiment described below does not unreasonably limit the content of the present invention as claimed in the claim section. Further, it is not necessary that all components of the configuration described below are essential elements of the present invention.

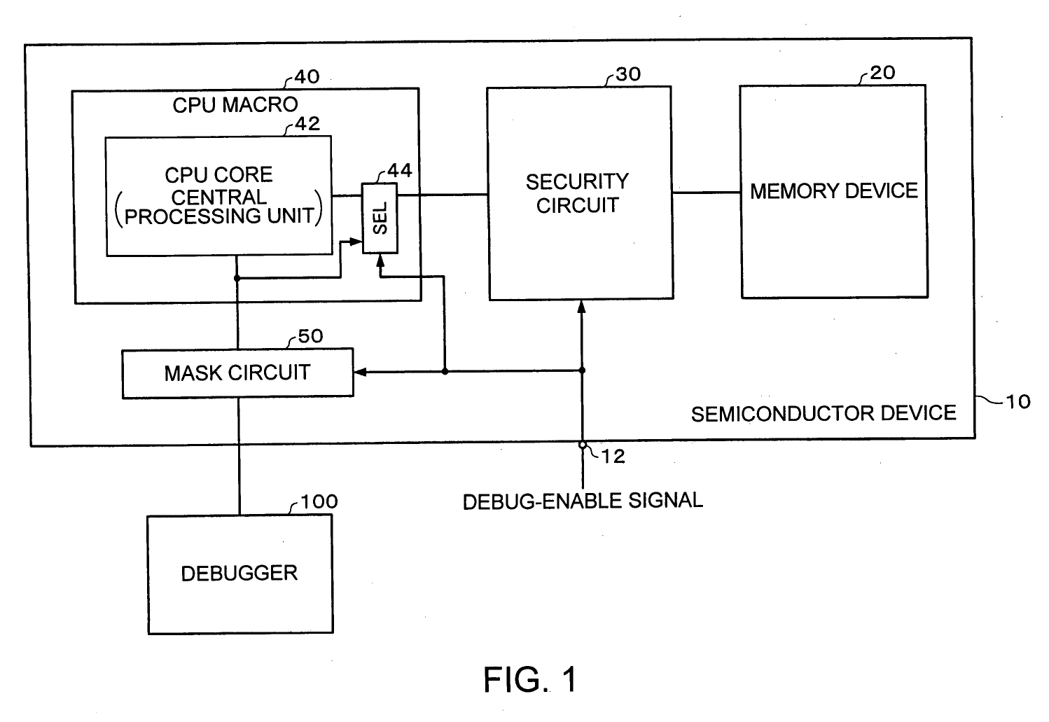

FIG. 1 shows a block diagram of a principle configuration of the semiconductor device according to the present embodiment.

The semiconductor device 10 (IC, semiconductor circuit, semiconductor integrated circuit) includes a memory device 20 and a security circuit 30. The memory device 20 stores the access data of the CPU (central processing unit). The memory device 20 can be called as a main memory. The security circuit 30 restricts access of the CPU or a debugger 100 to the memory device 20. The debugger 100 having an emulation function of the CPU accesses the memory device 20 as a substitute of the CPU in its debugging mode. The CPU emulation function of the debugger 100 is realized by the hardware installing the software therein to perform a process corresponding to the software.

The semiconductor device 10 can include a CPU macro 40. The CPU macro 40 includes a CPU core 42. The CPU core 42 can be called as the CPU which reads the program therein to execute the process corresponding to the program. The rest part of the CPU macro 40 other than the CPU core 42 can be called as a peripheral circuit of the CPU. In the present embodiment, the peripheral circuit includes a selector 44 which outputs debug signals (address signals, data signals, access control signals, and so on) from the debugger 100 as signals from the CPU core 42 in the debugging mode.

Note that, since only the selector 44 is shown in FIG. 1, an additional selector for outputting signals to be input to the CPU core 42 to the debugger 100 in the debugging mode can also be included.

According to such a configuration, the CPU core 42 accesses the memory device 20 via the security circuit 30 in a normal operation mode. When retrieving data stored in the memory device 20, the CPU core 42 outputs the address signals, an output control signal, and a chip select signal (the access control signals) to read the data stored in the memory device 20 in the CPU core 42. In this case, the address signals, the output control signal, and the chip select signal (the access control signals) can be called as access signals. More specifically, these access signals are signals for retrieving data stored in the memory device 20.

Similarly, when writing data in the memory device 20, the CPU core 42 outputs the address signals corresponding to the area of the memory device 20 to which the data is written, the data signals, a write control signal, and the chip select signal to store the data corresponding to the data signals. In this case, the address signals corresponding to the area of the memory device 20 to which the data is written, the data signals, a write control signal, and the chip select signal can be called as the access signals. More specifically, these access signals are signals for writing data in the memory device 20.

In the debugging mode, the functions of the CPU core 42 is disabled to make the debugger 100 substitute the functions of the CPU core 42, and the debugger 100 accesses the memory device 20 via the CPU macro 40 and the security circuit 30 similarly to the case described above. In this case, the debugger 100 can read the data stored in the memory device 20 by outputting the address signals for the memory device 20, the output control signal, and the chip select signal (the access control signals) (the access signals in a broad sense). Likewise, the debugger 100 can write the data corresponding to the data signals to the memory device 20 by outputting the address signals of the area in the memory device 20 to which the data is written, the write control signal, and the chip select signal (the access control signals) (the access signals in a broad sense).

The debugging function is set to either an enabled state or a disabled state in accordance with a debug-enable signal. When the debugging function is in the enabled state, it can be called as a debugging mode duration. When the debugging function is in the disabled state, it can be called as a normal operation mode duration. The semiconductor device 10 includes a debug-enable signal input terminal 12, through which the debug-enable signal is input from the outside of the semiconductor device 10.

When the debug-enable signal becomes inactive to set the debugging function of the debugger 100 to the disabled state, the semiconductor device 10 invalidates the access signals to the semiconductor device 10 from the debugger 100. Further the security circuit 30 validates the access to the memory device 20 and allows the CPU core 42 to access the memory device 20.

Meanwhile, when the debug-enable signal becomes active to set the debugging function to the enabled state, the semiconductor device 10 validates the access signals to the semiconductor device 10 from the debugger 100. And the security circuit 30 validates the access to the memory device 20 and allows the debugger 100 to access the memory device 20.

In order for executing the validation control or the invalidation control of the access signals from the debugger 100, the semiconductor device 10 can include a mask circuit 50. The mask circuit 50 is able to validate or invalidate the access signals from the debugger 100 in accordance with the debug-enable signal.

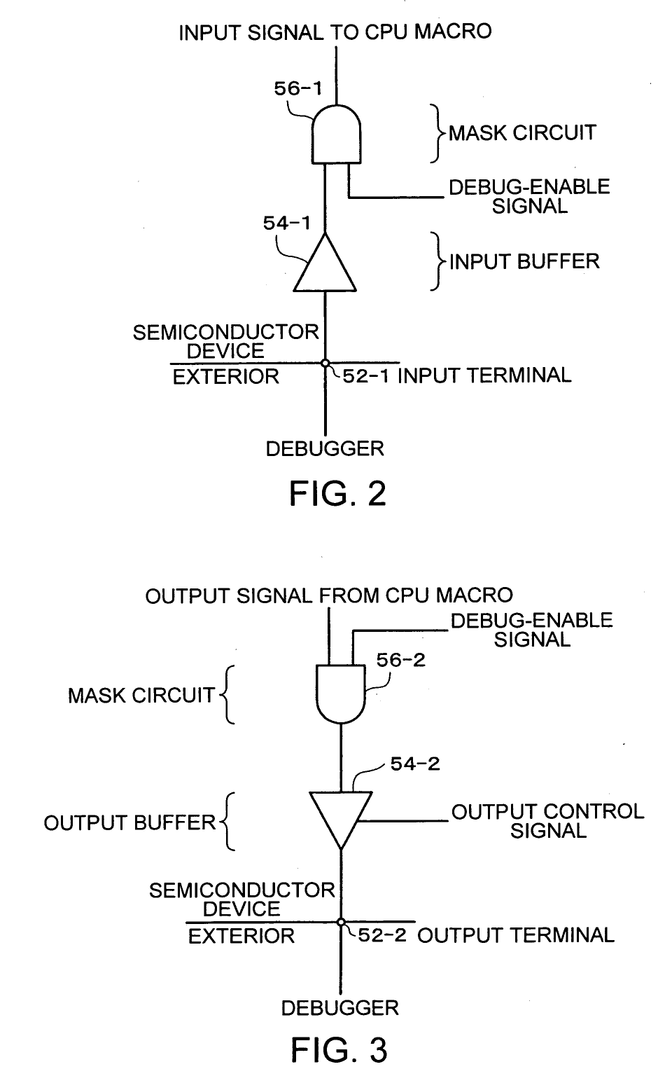

FIG. 2 shows a circuit diagram of a configuration example of the mask circuit 50. In FIG. 2, the configuration example of the mask circuit 50 for masking input signals (access signals) to the CPU macro 40 from the debugger 100 is shown. In FIG. 2, the debugging function is assumed to be set to the enable state when the debug-enable signal is in the high level (the active state).

The input signal from the debugger 100 is input to the semiconductor device 10 via the input terminal 52-1. The input signal input via the input terminal 52-1 is buffered by an input buffer 54-1 and then supplied to an input of a mask circuit 56-1. The mask circuit 56-1 implements a logical multiplication operation of the debug-enable signal by the output of the input buffer 54-1 to output the result as an input signal to the CPU macro 40. By thus operating, an input from the debugger 100 can be invalidated when the debug-enable signal is in an active state while the input from the debugger 100 can be validated when the debug-enable signal is in an inactive state.

FIG. 3 shows a circuit diagram of another configuration example of the mask circuit 50. In FIG. 3, the configuration example of the mask circuit 50 for masking output signals (access signals) to the debugger 100 from the CPU macro 40 is shown.

The output signal of the CPU macro 40 is supplied to an input of a mask circuit 56-2. The mask circuit 56-2 implements a logical multiplication operation of the debug-enable signal by the output signal from the CPU macro 40 to output the result to an output buffer 54-2.

The output of the output buffer 54-2 is controlled by an output control signal so that the output buffer 54-2 buffers and then outputs the output of the mask circuit 56-2 when the output control signal is active, or sets its output to the high impedance state when the output control signal is inactive. The output of the output buffer 54-2 is connected to an output terminal 52-2.

By thus configuring, the output to the debugger 100 can be invalidated when the debug-enable signal is inactive while the output to the debugger 100 can be validated when the debug-enable signal is active.

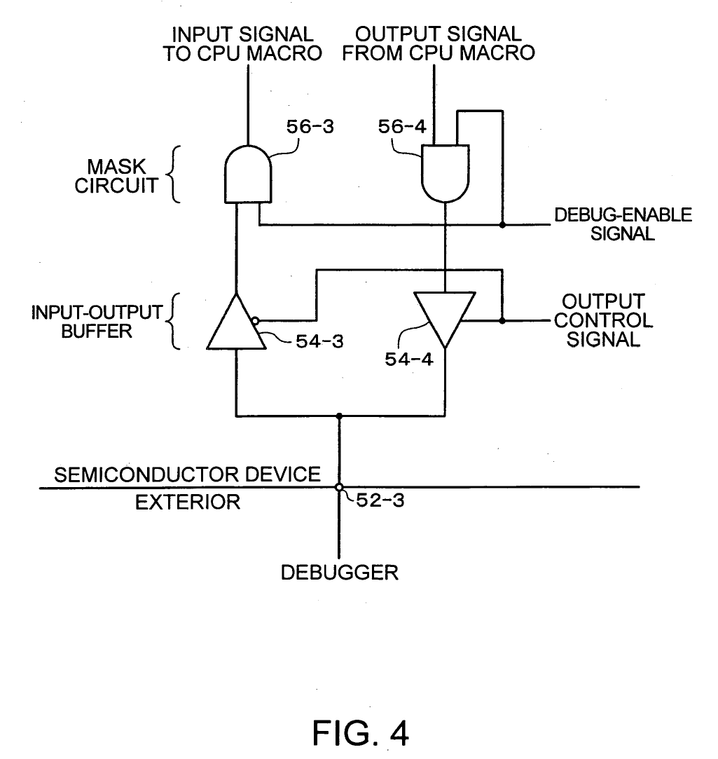

FIG. 4 shows a circuit diagram of still another configuration example of the mask circuit 50. In FIG. 4, the configuration example of the mask circuit 50 for masking input-output signals (access signals) between the CPU macro 40 and the debugger 100 is shown. Here, in the semiconductor device 10, the input signals to the semiconductor device 10 are assumed to be output to an output-only bus from the input buffers of the mask circuit 50, and the output signals from the semiconductor device 10 are assumed to be input to the output buffers from an output-only bus.

The input-output operations of the input buffer 54-3 and the output buffer 54-4 are controlled by the output control signal so as to buffer and then output the output of the mask circuit 56-4 to the input-output terminal 52-3 when the output control signal is in an active state, or to buffer and then output the input signal of the input-output terminal 52-3 to the mask circuit 56-3 when the output signal is in an inactive state.

Accordingly, the input signal from the debugger 100 input to the semiconductor device 100 via the input terminal 52-3 is buffered by the input buffer 54-3 and then supplied to the input of the mask circuit 56-3. The mask circuit 56-3 implements a logical multiplication operation of the debug-enable signal by the output of the input buffer 54-3 to output the result as an input signal to the CPU macro 40.

The output signal of the CPU macro 40 is supplied to an input of a mask circuit 56-4. The mask circuit 56-4 implements a logical multiplication operation of the debug-enable signal by the output signal from the CPU macro 40 to output the result to an output buffer 54-4. The output of the output buffer 54-4 is connected to an input-output terminal 52-3.

As described above, the access signals between the debugger and the semiconductor device 10 can be controlled to be valid or invalid. Further, in the present embodiment, the debug-enable signal does not need to be generated by the debugger 100, and, for example in the debugging system, the debug-enable signal input terminal 12 can be arranged to be fixed to the H level. Thus, the debugger 100 does not need to be dedicatedly designed, and a universal debugger can be used therefore. In other words, the debugger 100 can be disabled to access the memory device 20 unless the debug-enable signal is set to the active state, thus maintaining secrecy of the memory device 20 with a simple configuration.

Note that, in the present embodiment, the illegal access from the debugger 100 is preferably restricted in the debugging mode in which the debug-enable signal becomes active. Hereinafter, a detailed example of a configuration of the semiconductor device and the system using the semiconductor device which uses a universal debugger 100 and is capable of restricting the illegal access from the debugger 100.

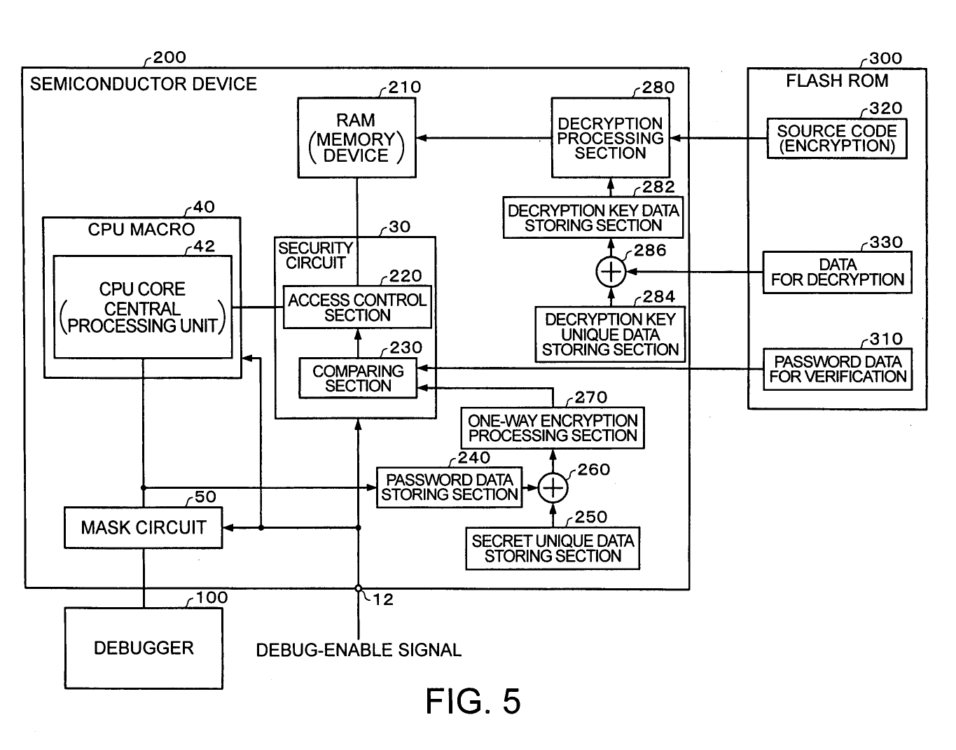

FIG. 5 shows a block diagram of a detailed configuration example of a semiconductor device and a configuration example of a system using the semiconductor device according to the present embodiment. Note that the same parts as those of the semiconductor 10 shown in FIG. 1 are denoted with the same reference numerals and explanations therefore are omitted if appropriate. Note also that the semiconductor device of the present embodiment does not need to include all of the circuits and units (sections) shown in FIG. 5, but can adopt a configuration in which a part thereof is omitted.

In FIG. 5, the semiconductor device 200 has functions of the semiconductor device 10 shown in FIG. 1. The semiconductor device 200 includes the debug-enable input terminal 12, RAM (Random Access Memory) 210 having the functions of the memory device 20 of FIG. 1, the security circuit 30, the CPU macro 40, and the mask circuit 50. The CPU macro 40 includes the CPU core 42.

In the semiconductor device 200, the access signal to the semiconductor device 200 from the debugger 100 is enabled in the debugging mode, while the security circuit 30 once disables access to the RAM 210. And then, the security circuit 30 enables the debugger to access the RAM 210 providing input data expressed by at least a part of the access signals from the debugger 100 is predetermined data.

Therefore, the security circuit 30 can include an access control section 220.

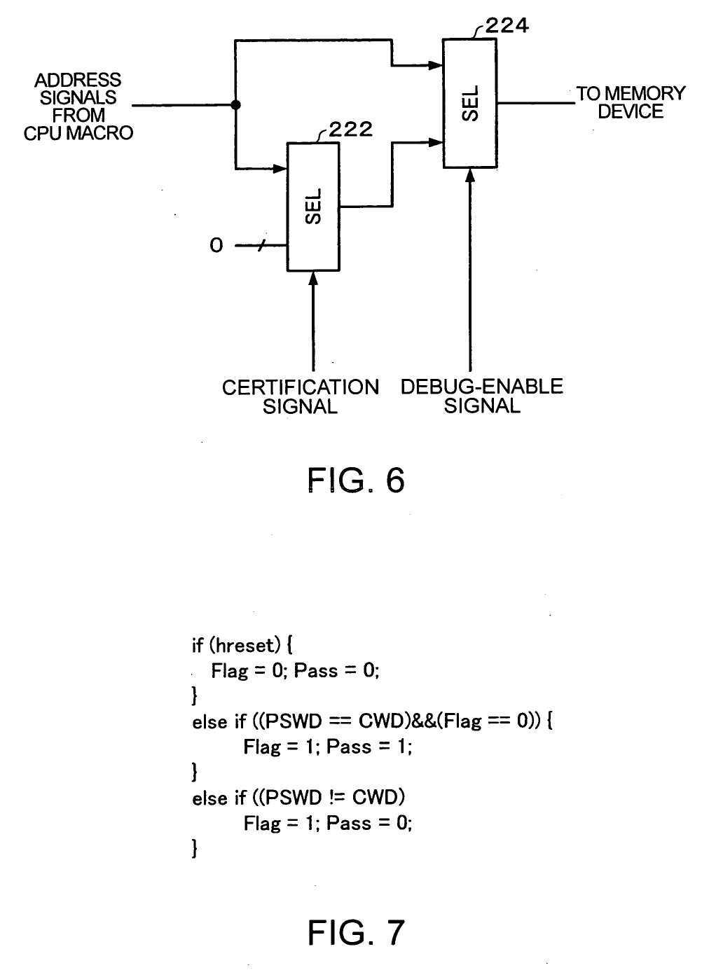

FIG. 6 shows a block diagram of a configuration example of the access control section 220. Although, in this example, only the configuration for controlling the address signals from the CPU macro 40 is described, the access control signals (the output control signal, the write control signal, and the chip select signal) from the CPU macro 40 can also be controlled as well.

The access control section 220 includes selectors 222, 224. Input to the access control section 220 are the address signals output by the CPU core 42 in the normal operation mode or the address signals output by the debugger 100 in the debugging mode. These address signals are input to the selectors 222, 224.

The selector 222 outputs either of the address signals of a fixed value such as a value with each bit fixed to zero or the address signals from the CPU macro 40 in accordance with a certification signal. If the access from the debugger 100 is judged to be illegal, the certification signal becomes inactive, and if the access from the debugger 100 is judged to be proper (not illegal), the certification signal becomes active. And then, the selector 222 outputs the fixed value when the certification signal is inactive, and outputs the address signals from the CPU macro 40 when the certification signal is active. Note that the present invention is not limited to the fixed value of zero, but the value of the address signal with which the access to the RAM 210 is disabled when the certification signal becomes inactive in the debugging mode will do.

The selector 224 selects to output either of the address signals or the output of the selector 222 from the CPU macro 40 in accordance with the debug-enable signal. When the debug-enable signal is inactive, namely in the normal operation mode, the address signals from the CPU macro 40 are selected to be output. Therefore, since the address signals from the CPU macro 40 are the address signals output by the CPU core 42 in the normal operation mode, the address signals output by the CPU core 42 are output to the RAM 210.

In contrast, the selector 224 outputs the output of the selector 222 when the debug-enable signal is active, namely in the debugging mode. In the debugging mode, the address signals from the CPU macro 40 are the address signals output by the debugger 100. Therefore, if the certification signal is active in the debugging mode, the address signals output by the debugger 100 are output to the RAM 210, and if the certification signal is inactive in the debugging mode, the address signals having the value for disabling the access to the RAM 210 is output to the RAM 210.

By the process as described above, when the access to the RAM 210 by the debugger 100 or the CPU core 42 is enabled, the access control section 220 can release masking of the address signals and the access control signals output by the debugger 100 or the CPU core 42. Further, when the access to the RAM 210 by the debugger 100 or the CPU core 42 is disabled, the access control section 220 can mask the address signals and the access control signals output by the debugger 100 or the CPU core 42.

In order for generating such a certification signal, the security circuit 30 can further include a comparing section 230.

In FIG. 5, the comparing section 230 compares the input data from the debugger 100 with a predetermined data in the debugging mode, and if the data matches, it judges that the access from the debugger 100 is proper, and outputs the certification signal to be active. Further, if the data do not match, the comparing section 230 judges that the access from the debugger 100 is illegal, and outputs the certification signal to be inactive.

Further, if the semiconductor device 200 receives the input data from the debugger 100 as password data, as described above, a series of data with continuous values may illegally be input from the debugger 100 as the password data. The security should be maintained even in such a situation. Therefore, the semiconductor device 200 is arranged to execute an encryption process to the password from the debugger 100 and then compare the encrypted password data with the predetermined password data for certification to judge whether or not the access from the debugger 100 is illegal.

Further, it is not desirable in view of maintaining security that various users of the debugger 100 can access the RAM 210 with the same password data. Therefore, in the present embodiment, the secret unique data is provided for each of the users so that the debugger 100 can judge whether or not the access from the debugger 100 is illegal by comparing the password data for certification with password data processed by an encryption process based on the password data from the debugger 100 and the secret unique data.

In order for realizing the above functions, the semiconductor device 200 can include a password data storing section 240, a secret unique data storing section 250, a password data combining section 260, and one-way encryption processing section (encrypted password data generating section, in a broad sense) 270.

The input data from the debugger 100 is stored in the password storing section 240 as password data (vender-unique password data) in the debugging mode. The secret unique data is previously stored in the secret data storing section 250. The secret unique data is different with respect to each one or a plurality of semiconductor devices, and can be different with respect to each manufacturing lot of the semiconductor device or each user of the debugger 100, for example.

The password data combining section 260 generates combined password data based on both the input data from the debugger 100 and the secret unique data stored in the secret unique data storing section 250. Such a password data combining section 260 as described above can output the result of the logic operation EXCLUSIVE OR of the input data with the secret unique data as the combined password data, for example. Alternatively, the password combining section 260 can combine the input data and the secret unique data in the bit aligning direction of the data to output as the combining password data, for example. Further, the password data combining section 260 can execute some bit operations under a predetermined rule such as exchanging or elimination of a predetermined bit of at least one of the input data and the secret unique data to output as the combined password data, for example.

The one-way encryption processing section 270 outputs encrypted password data generated by executing a one-way encryption process to the combined password data generated by the password data combining section 260. Here, the one-way encryption process can disable to figure out the unprocessed value from the processed value by eliminating information during the process. Although the one-way encryption processing section 270 can be replaced with an encryption processing section which simply performs encryption process using an encryption key, the one-way encryption process is more desirable because it does not require any encryption keys and can be realized with a relatively simple configuration. As the one-way encryption process, there can be cited, one utilizing the hash function such as SHA-1 (Secure Hash Algorithm 1), or MD5 algorithm (The MD5 Message-Digest Algorithm) or the like. Since the contents of the SHA-1 and MD5 algorithm are known to the public, detailed descriptions will be omitted here.

And, the comparing section 230 compares the encrypted password data output by the one-way encryption processing section 270 with predetermined password data for verification. And, when the both password data match, the access from the debugger 100 is judged as proper, and accordingly the certification signal to be active is output. As a result, the access control section 220 outputs the address signals and the access control signals from the debugger 100 to the RAM 210, and the security circuit 30 enables access to the RAM 210, thus enabling the debugger 100 to access the RAM 210.

Meanwhile, when the both password data do not match, the access from the debugger 100 is judged as illegal, and accordingly the certification signal to be inactive is output. As a result, the access control section 220 is masked in the address signals and the access control signals, and the security circuit 30 disables access to the RAM 210.

Note that the password data for verification is stored in a flash ROM (Read Only Memory) 300 as a nonvolatile memory device (external memory device) provided outside the semiconductor device 200. On a system board composing a system shown in FIG. 5, there are mounted the semiconductor device 200 and the flash ROM 300 which stores the password data 310 for verification when debugging the semiconductor device 200.

Note that the flash ROM 300 can be provided inside the semiconductor device 200. Further, since reading and/or writing operations of memory device 20 (main memory device), which is accessed by the CPU (central processing unit), is involved in the operation speed of the semiconductor device 200, it is desirable that the speed of the reading and/or writing operation of the memory device 20 is higher than those of reading and/or writing operations of the flash ROM 300.

Further, in the semiconductor device 200, it is desirable that an attack with a series of password data having continuous values can effectively be prevented. The semiconductor device 200 is arranged to receive the following access signals (input data) from the debugger 100, providing the semiconductor device 200 is hardware-reset when the debugger 100 is disabled (invalidated) to access to the RAM 210. In other words, for example, the mask circuit 50 can be arranged not to enable the succeeding access signal (input data) unless the semiconductor device 200 is hardware-reset, or the comparing section 230 can be arranged so that the certification signal once set inactive cannot be changed unless the semiconductor device 200 is hardware-rest. Hereinafter, the case realized with the latter way will be described.

FIG. 7 shows a description example of a hardware description language for explaining the operation of the comparing section 230. In this case, a hardware-reset signal for hardware-resetting the semiconductor device 200 is denoted as “hreset,” the encrypted password data as “PSWD,” the password data for verification as “CWD,” and the certification signal as “Pass.” And, the values of the certification signal Pass is assumed to be 1 when active, or 0 when inactive.

By operating the comparing section 230 as shown in FIG. 7, after the certification signal Pass is once set to 0, the state of the certification signal Pass cannot be updated unless the hardware reset signal “hreset” is set to 1. Thus, when the password data CWD for verification does not match with the encrypted password data PSWD, the succeeding data (the access signals) from the debugger 100 can be received providing the semiconductor device 200 is hardware-reset.

In this case, when, for example, a user of the debugger 100 attack the semiconductor device 200 with a series of data of continuous values using illegal dedicated software, a correct password can be found in a short period of time if the system easily accepts the next password to the wrong password. Therefore, a password with a sufficiently long bit length is required to avoid the above.

However, by adopting the system which accepts the next password from the debugger 100 after a wrong password only if the semiconductor device 200 is hardware-reset, as is the case of the present embodiment, security can be maintained with a shorter bit length of password. For example, assuming that the reset time by the hardware-rest is one second and the bit length of the password data is s (a positive integer) bits, the certification signal Pass can be set to active when 2^{s}×1 seconds has passed.

Further, in addition to preventing the illegal access from the debugger 100 as described above, it is desirable that the source code (source code data) in the flash ROM 300 is also encrypted.

In this case, as shown in FIG. 5, the semiconductor device 200 can include a decryption processing section 280 and a decryption key data storing section 282. The decryption processing section 280 perform the decryption process using decryption key data stored in the decryption key data storing section 282. The decryption processing section 280 can execute the decryption process with, for example, the DES (Data Encryption Standard) algorithm. Note that the decryption processing section can use other algorithms than the DES. Since the algorithm of the DES is known to the public, descriptions therefore will be omitted.

As a result, when the security circuit 30 enables the debugger 100 to access the RAM 210, the debugger 100 can read the data decrypted by the decryption processing section 280. In this case, it is desirable that the decryption processing section 280 develops the decrypted source code data (the source code) in the RAM 210 providing that the access by the debugger is validated, and then the debugger 100 accesses the data developed in the RAM 210.

Note that the source code data to which the decryption processing section 280 is to execute the decryption process is stored in the flash ROM 300. The data is a source code (compiled code) 320 of a program, which the CPU core 42 or the debugger 100 executes, and is assumed to include parameters or other information. Further, the source code data 320 has already been encrypted when it is written to the flash ROM 300. The encryption process is executed using the DES algorithm. In other words, the source code encrypted using the encryption process corresponding to the decryption process of the decryption processing section 280 is stored in the flash ROM 300.

A decryption key data combining section 286 generates the decryption key data based on both decryption key unique data stored in a decryption key unique data storing section 284 and data 330 for decryption set previously. Such a decryption key data combining section 286 is able to output, for example, the result of logic operation EXCLUSIVE OR of the decryption key unique data and the data for decryption as the decryption key data. Alternatively, the decryption key data combining section 286 is able to output, for example, the decryption key unique data and the data for decryption combined in the data bit aligning direction to the decryption key data storing section 282. Further, the decryption key data combining section 286 can execute some bit operations under a predetermined rule such as exchange or elimination of a predetermined bit of at least one of the decryption key unique data and the data for decryption to output as the decryption key data, for example. Note that the data 330 for decryption is stored in the flash ROM 300.

The data 330 for decryption can be changed with respect to each of the semiconductor devices. As a result, the encryption and the decryption are executed with the key data different with respect to each of the semiconductor device, thus providing high level of security.

Here, an example of setting the data stored in the flash ROM 300 will be described. The password data 310 for verification, the source code 320, and the data 330 for decryption are stored in the flash ROM 300 when developing (designing) the system. In the present invention, setting of the data in the flash ROM 300 is carried out by an external system. The function of the external system here can be realized by hardware such as a personal computer and an application program (software) running on an operating system implemented in the personal computer. And then, the source code (the source program and parameters), the various key data, and the various unique data set by the external system are written in the flash ROM 300.

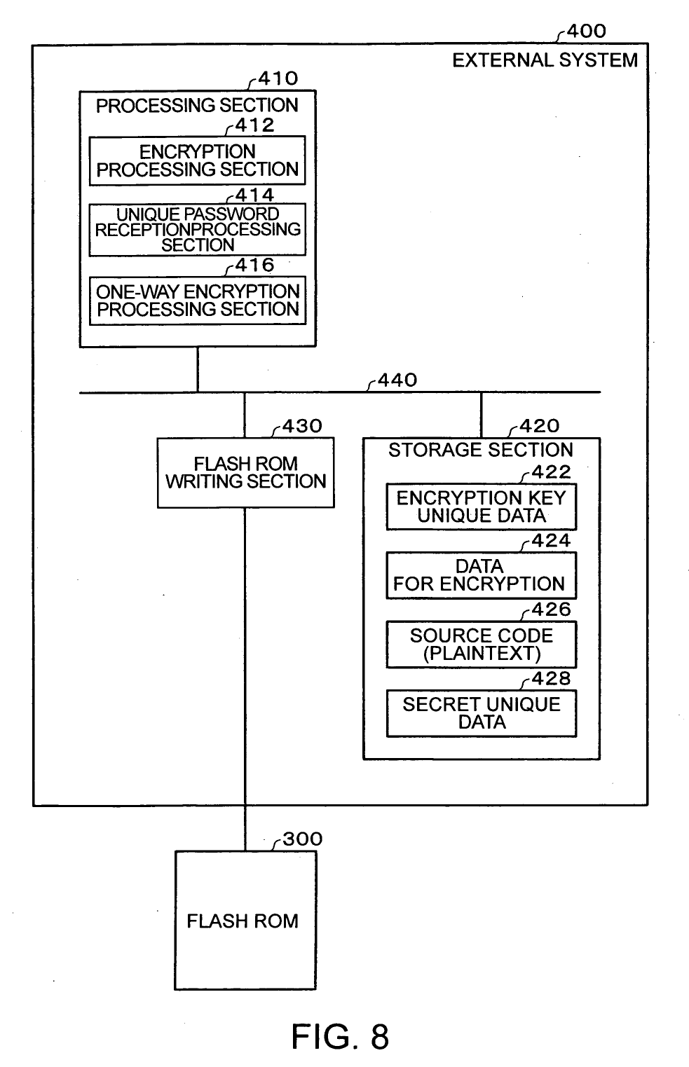

FIG. 8 shows a configuration example of a functional block diagram of the external system in the present embodiment.

The external system 400 includes a processing section 410, a storage section 420, and a flash ROM writing section 430. In the external system 400, the processing section 410, the storage section 420, and the flash ROM writing section 430 are connected via a bus 440.

The processing section 410 retrieves the data or the program stored in the storage section 420 to execute the process. The processing section 410 includes an encryption processing section 412, a unique password reception processing section 414, and a one-way encryption processing section 416. The function of the processing section 410 is realized with hardware such as a CPU or an ASIC (Application Specific Integrated Circuit).

The storage section 420 includes encryption key unique data 422, data 424 for encryption, a source code (plaintext) 426, and secret unique data 428. Further, the storage section 420 stores program data for realizing processes of the encryption processing section 412, the unique password reception processing section 414, and the one-way encryption processing section 416 in the processing section 410. The function of the storage section 420 is realized with hardware such as a RAM or a ROM.

The flash ROM writing section 430 executes a process of writing the data generated by the processing section 410 into a predetermined area of the flash ROM 300.

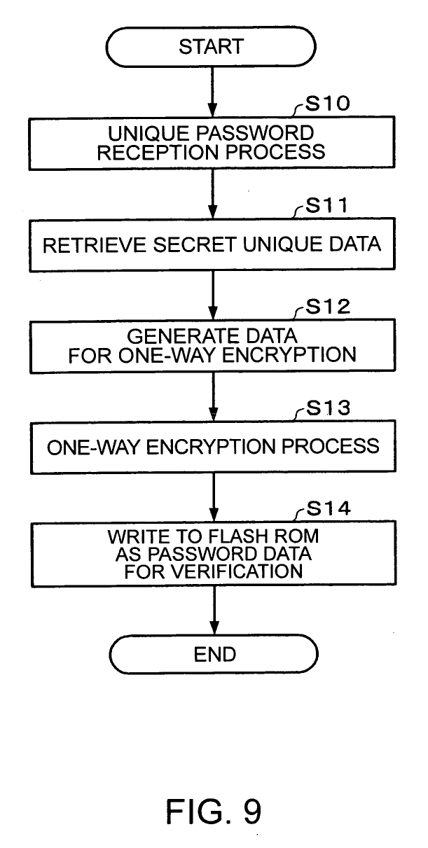

FIG. 9 shows an example of a flowchart corresponding to the writing process of the password data for verification executed by the external system 400 shown in FIG. 8. The program for realizing the process of the flowchart shown in FIG. 9 is stored in the storage section 420, and the processing section 410 retrieves the program to realize the following process.

Firstly, the processing section 410 executes a process of receiving vender unique password data from the user (step S10).

Subsequently, the processing section 410 retrieves the secret unique data 428 from the storage section 420 (step S11). Note that the secret unique data 428 is equivalent to the secret unique data stored in the storing section 250.

And, the processing section 410 generates data for one-way encryption with the same process as of the password data combining section 260 of the semiconductor device 200 using the vender unique password data received in the step S10 and the secret unique data 428 (step S12).

Subsequently, the processing section 410 executes the one-way encryption process on the data for one-way encryption generated in the step S12 (step S13). Note that the one-way encryption process in the step S13 is the same as that of the one-way encryption processing section 270.

After then, the processing section 410 instructs the flash ROM writing section 430 to execute the process of writing the processing result of the one-way encryption process obtained in the step S13 into the flash ROM 300 as the password data for verification to terminate the series of processes (end).

As described above, if a different password is assigned to each user, and in the debugging mode the password data from the debugger 100 is different from the vender unique password data received in the step S10, the access from the debugger 100 is judged as illegal. Further, if the secret unique data retrieved in the step S11 and the secret unique data of the semiconductor device which is the debugging target are different from each other, the access from the debugger 100 is judged as illegal.

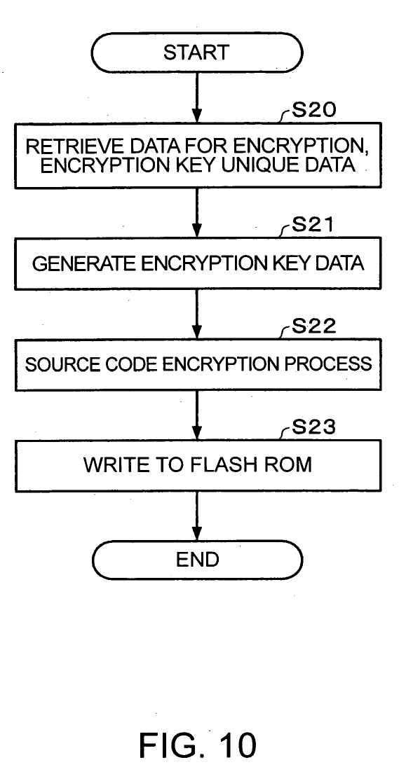

FIG. 10 shows an example of a flowchart corresponding to the writing process of the source code executed by the external system 400 shown in FIG. 8. The program for realizing the process of the flowchart shown in FIG. 10 is stored in the storage section 420, and the processing section 410 retrieves the program to realize the following process.

Firstly, the processing section 410 retrieves the encryption key unique data 422 and the data 424 for encryption both stored in the storage section 420 (step S20).

Subsequently, the processing section 410 generates the encryption key data based on both the encryption key unique data 422 and the data 424 for encryption (step S21). Note that the encryption key data and the decryption key data stored in the decryption key data storing section 282 make a pair.

And then, the processing section 410 executes the encryption process of the source code stored in the storage section 420 according to the algorithm of the DES which uses the encryption key data generated in the step S21 (step S22). The encryption process makes a pair with the decryption process of the decryption processing section 280 in the semiconductor device 200, thus it is arranged that the data which has not yet been processed by the encryption processing section 412 is equal to the data decrypted by the decryption processing section 280.

After then, the processing section 410 instructs the flash ROM writing section 430 to execute the process of writing the source code encrypted in the step S22 into the flash ROM 300 (step S23) to terminate the series of processes (end).

Hereinafter, an operational example of the system shown in FIG. 5 after the flash ROM 300 has been configured as described above will be explained.

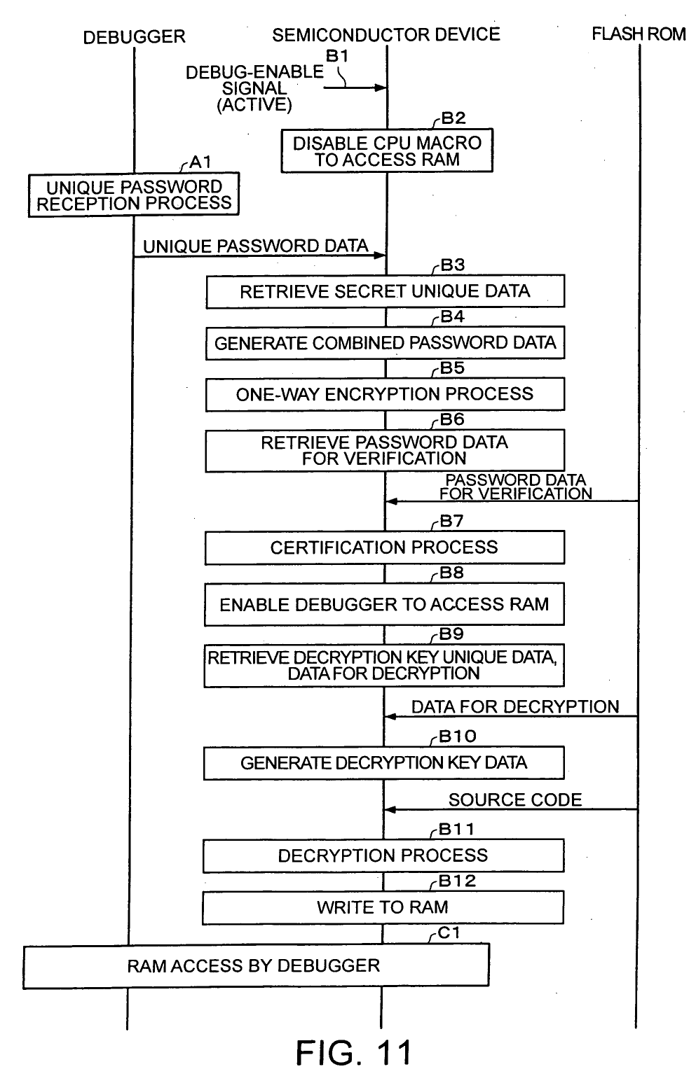

FIG. 11 shows an example of an operational sequence of the system shown in FIG. 5. FIG. 11 shows sequences of the operational examples of both units, the semiconductor device 200 and the flash ROM 300, as well as a sequence of the operational example of the interface between the units. FIG. 11 shows a sequence of the case in which the access from the debugger 100 is judged as proper in accordance with the password data from the debugger 100.

Firstly, in the semiconductor device 200, the debugger 100 is connected, and the debug-enable signal of the active state is supplied to the debug-enable signal input terminal 12 (B1). Thus, in the semiconductor device 200, the access to the RAM 210 from the CPU macro 40 is temporarily disabled by the security circuit 30 (B2). Further, the mask circuit 50 validates the input data from the debugger 100.

Meanwhile, in the debugger 100, the unique password reception process is executed by software (A1). If the user input the vender unique password data here, the debugger 100 writes the password data into the password storing section 240 of the semiconductor device 200.

In the semiconductor 200, if the password data from the debugger 100 is written into the password data storing section 240, the secret unique data is retrieved from the secret unique data storing section 250 (B3). Subsequently, the semiconductor device 200 generates the combined password data from the password data written into the password data storing section 240 and the secret unique data (B4), and executes one-way encryption process on the combined password data (B5).

And then, the semiconductor device 200 retrieves the password data 310 for verification in the flash ROM 300 (B6). Further, the certification process for comparing the processing result of the one-way encryption process with the password data 310 for verification from the flash ROM 300 (B7).

The both sides match with each other when the password data from the debugger 100 and the password data received in the step S10 in FIG. 9 are the same, and the secret unique data stored in the secret unique data storing section 250 and the secret unique data 428 are also the same.

And, when the processing result of the one-way encryption process matches with the password data 310 for verification, the access from the debugger 100 is judged as proper and the access to the RAM 210 from the debugger 100 is enabled (B8).

And then, in the semiconductor device 200, the decryption key unique data stored in the decryption key unique data storing section and the data 330 for decryption stored in the flash ROM 300 are retrieved (B9).

The semiconductor device 200 generates the decryption key data based on the decryption key unique data and the data for decryption (B10). The decryption key data is stored in the decryption key data storing section 282. Thus, the semiconductor device 200 executes the decryption process using the decryption key data stored in the decryption key data storing section 282 while retrieving source code stored in the flash ROM 300 (B11). And then, it writes the decrypted data into the RAM 210, and develops the decrypted source code in the RAM 210 (B12).

Thus, it becomes possible that the debugger 100 having the function of emulating the CPU core 42 retrieves the decrypted source code developed in the RAM 210 to execute the process corresponding to the source code or refers to the data included in the source code (C1).

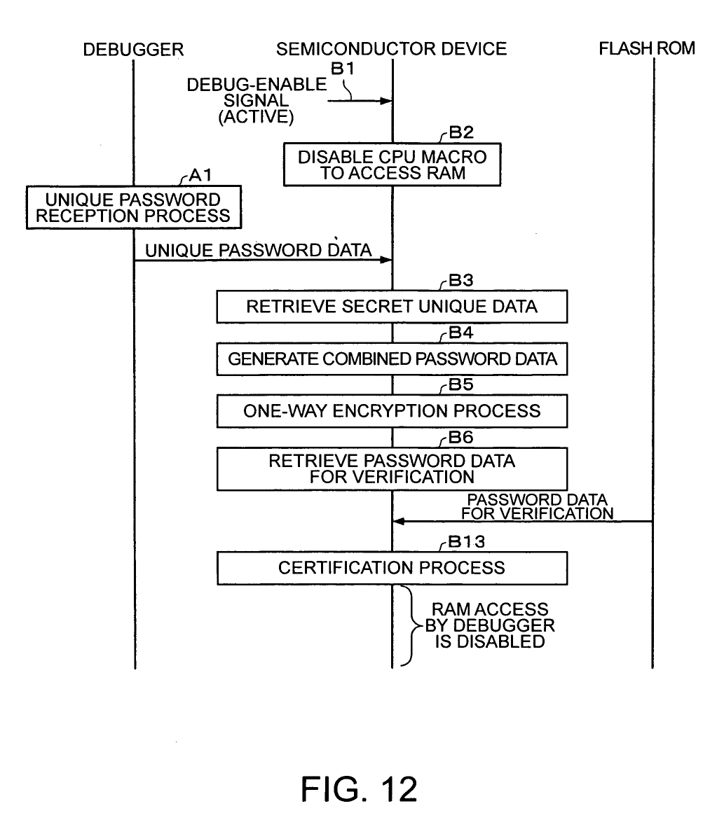

FIG. 12 shows another example of the operational sequence of the system shown in FIG. 5. Similarly to FIG. 11, FIG. 12 shows a sequence of an operational example of the units, the debugger 100, the semiconductor device 200, and the flash ROM 300. Further, FIG. 12 shows a sequence of the case in which the access from the debugger 100 is judged as illegal in accordance with the password data from the debugger 100. Note that, in FIG. 12, the same process sections as those in FIG. 11 are denoted with the same reference numerals and explanations therefore are omitted if appropriate.

Since the sequences up to the retrieval of the password data for verification (B6) in the semiconductor device 200 are the same as those in FIG. 11, descriptions therefore will be omitted.

After retrieving the password data for verification, if the processing result of the one-way encryption process does not match with the password data 310 for verification, the access from the debugger 100 is judged as illegal, and the access to the RAM 210 from the debugger 100 is disabled (B13).

After then, even if the unique password reception process is executed in the debugger 100, and another unique password data is input to the semiconductor device 200, the access from the debugger 100 is never judged as proper. Therefore, it is arranged to leave no option but to hardware-reset the semiconductor device 200.

Hereinafter, a configuration example of a data transfer control device applying the semiconductor device 200 according to the present embodiment will be explained.

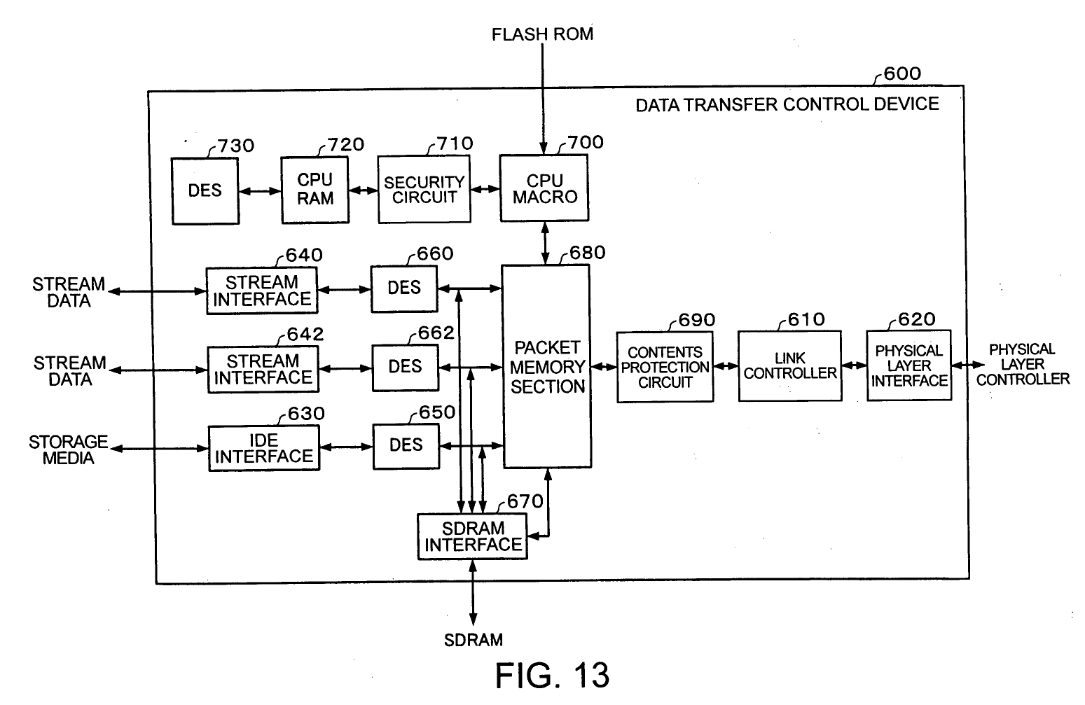

FIG. 13 shows a block diagram of a configuration example of the data transfer control device applying the semiconductor device 200 of the present embodiment. Note also that the data transfer control device shown in FIG. 13 does not need to include all of the circuits and units (sections) shown in FIG. 13, but can adopt a configuration in which a part thereof is omitted.

The data transfer control device 600 controls data transfers between a stream data receiver device, a storage medium, and a general purpose (high speed) serial interface. As the stream data receiver device, for example, a digital broadcasting demodulator circuit can be cited. As the storage medium, for example, a hard disk drive (Hard Disk Drive, HDD) can be cited. As the general purpose (high speed) serial interface, IEEE 1394 interface and USB (Universal Serial Bus) 2.0 interface can be cited. In the following description, the IEEE 1394 interface is assumed to be used as the interface.

In FIG. 13, the data transfer control device 600 includes a link controller 610 and a physical layer interface 620. The link controller 610 realizes a data transfer control of the link layer compliant with the IEEE 1394 standard. The physical layer interface 620 realizes a physical layer interface with a physical layer controller (not shown) provided outside the data transfer control device 600. The physical layer controller is connected to a bus compliant with the IEEE 1394 standard to realize the data transfer control of the physical layer compliant with the IEEE 1394 standard. The bus is connected to other electronic equipment provided with the IEEE 1394 interface. Note that the physical layer controller can also be arranged to be embedded in the data transfer control device 600.

The data transfer control device 600 includes an IDE (Integrated Drive Electronics) interface 630 and stream interfaces 640, 642. The IDE interface 630 is a circuit for establishing an interface between the data transfer control device 600 and the storage medium.

As the storage medium for AV (Audio Visual) applications, an inexpensive HDD equipped with the IDE (ATA) interface widely used for personal computers is used. In contrast, in electronic equipments such as digital tuners (BS tuners, CS tuners), the IEEE 1394 interface is widely used as an interface for digital data (digital video data, digital audio data).

As shown in FIG. 13, by providing both the IEEE 1394 interface and the IDE interface, the conversion bridge function between the IEEE 1394 and IDE can be realized in the data transfer control device.

The stream interfaces 640, 642 are circuits for establishing interface between the data transfer control device 600 and a stream data receiver device or a image output device. For example, a receiving process of movie streaming data extracted from the received wave of digital broadcasting or a transmission process of streaming data to an image output device is executed.

Further, the data transfer control device 600 includes DES circuits 650, 660, 662 for executing the encryption process and the decryption process both compliant with the DES. The DES circuit 650 outputs the encrypted data to the IDE interface 630, or decrypts the data from the IDE interface 630. The DES circuit 660 outputs the encrypted data to the stream interface 640, or decrypts the data from the stream interface 640. The DES circuit 662 outputs the encrypted data to the stream interface 642, or decrypts the data from the stream interface 642.

The data transfer control device includes a SDRAM interface 670 for establishing an interface with the SDRAM (Synchronous Dynamic Random Access Memory). Note that the SDRAM is a memory device capable of offering faster sequential access (access to continuous addresses) compared to random access. Further, it is the memory device capable of inputting and outputting data with continuous addresses (burst data) in sync with a clock signal. The SDRAM functions as a cash memory for isochronous data.

Note that, although it is desirable to provide the SDRAM outside the data transfer control device 600, it can be provided inside the data transfer control device. Further, instead of a normal SDRAM, a high speed synchronous memory, such as DDR type of SDRAM or RDRAM supplied by Rambus Inc. can also be adopted.

Further, the storage area of the SDRAM can be divided into a transmission area and a reception area, or into an asynchronous area and an isochronous area.

The data transfer control device 600 includes a packet memory device 680. The packet memory device 680 is a RAM for packet transfer, and has smaller capacity compared to the SDRAM. Further, the packet memory device 680 is a memory device capable of performing high speed random access.

The packet memory device 680 has a function of temporally storing the packet received via a bus compliant with the IEEE 1394 standard. Further, it also has a function of temporally storing the packet retrieved from the storage medium for transferring via the bus compliant with the IEEE 1394 standard. Furthermore, it also has a function of temporally storing the packet of the stream data received via the stream interfaces 640, 642 in order for transferring via the bus compliant with the IDE or the bus compliant with the IEEE 1394 standard. Alternatively, it also has a function of temporally storing the packet received via the bus compliant with the IEEE 1394 standard or the packet retrieved from the storage medium in order for transferring via the stream interfaces 640, 642.

The data transfer control device 600 includes a contents protection circuit 690. The contents protection circuit 690 executes a process for encrypting, with the encryption process, the data (isochronous data) retrieved from the packet memory device 680, and then transferring it to the link controller 610. Further, it executes a process for decrypting, with the decryption process, the encrypted data (encrypted isochronous data) transferred from the link controller 610 side, and then writing it into the packet memory device 680.

The processes of the contents protection circuit 690 are executed for transmitting and receiving the encrypted data between electronic equipments (devices) connected via the bus compliant with the IEEE 1394 standard. In this case, prior to transmitting or receiving the encrypted data to be protected among the electronic equipments, a certification process is executed, which confirms whether or not the reception side of the electronic equipments is provided with a data protection feature. And, if it is confirmed with the certification process that the protection feature is provided, a cipher is exchanged among the electronic equipments. And, the transmission side of the electronic equipments transmits the encrypted data while the reception side of the electronic equipments decrypts the received encrypted data.

By thus processing, the protected data can be transmitted and received only between the electronic equipments. Accordingly, the contents of the data can be protected from such electronic equipment as lacking the protection feature or modifying the data.

Further, copy control information set by a contents supplier is also communicated among electronic equipments. Thus, the copy control such as “copy never,” “copy one generation,” or “copy free” becomes possible. Further, system renewability messages are also delivered with the contents. Accordingly, the data transfer to illegal electronic equipments can be inhibited or limited, thus prohibiting illegal copy from now to the future.

The data transfer control device 600 includes a CPU macro 700, a security circuit 710, a CPURAM 720, and a DES circuit 730. The CPU macro 700 has the functions of the CPU macro 40 shown in FIGS. 1 and 5. The security circuit 710 has the functions of the security circuit 30 shown in FIGS. 1 and 5. The CPURAM 720 has the functions of the memory device 20 shown in FIG. 1 of the RAM 210 shown in FIG. 5. The DES circuit 730 has the functions of the decryption processing section 280 and so on (the decryption processing section 280, the decryption key data storing section 282, the decryption key unique data storing section 284, and the decryption key data combining section 286).

The CPU macro 700 executes a process corresponding to a source code (source program and parameters (key data) for executing a process of the contents protection circuit 690) to control each section of the data transfer control device 600. The CPU macro 700 executes, for example, the process of the contents protection circuit 690. The source code is retrieved from a flash ROM provided inside or outside the data transfer control device 600 as an encrypted source code, and temporally written into the CPURAM 720. And then, it is decrypted by the DES circuit 730 and developed in the CPURAM 720 again. The security circuit 710 executes security protect on the CPURAM 720 as explained in the embodiment described above in order for preventing leakage of secrets by the debugger.

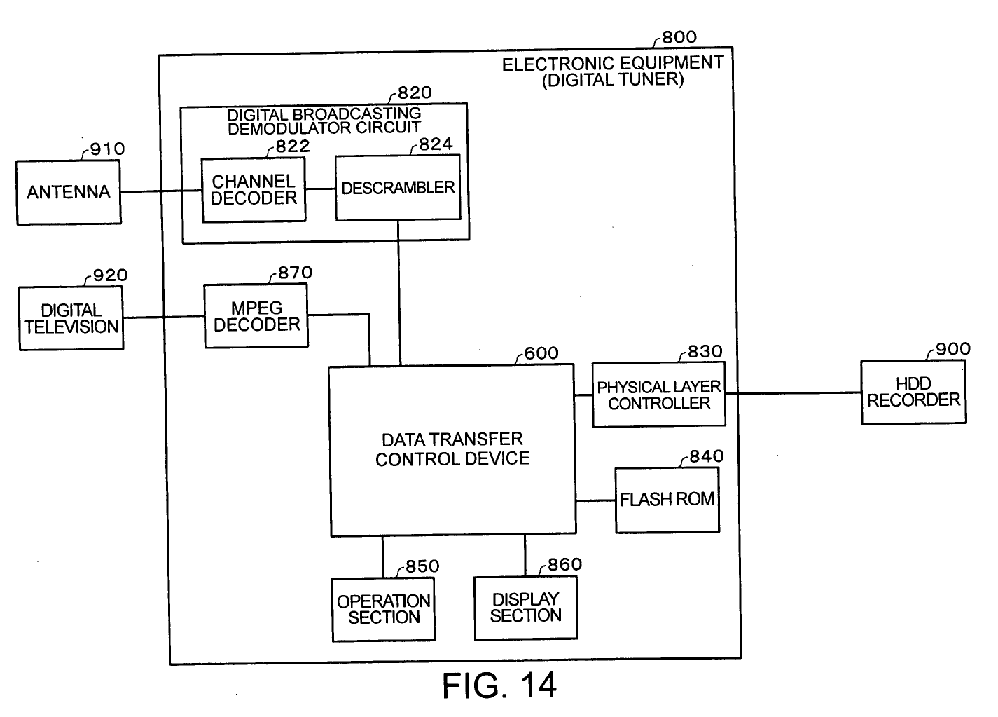

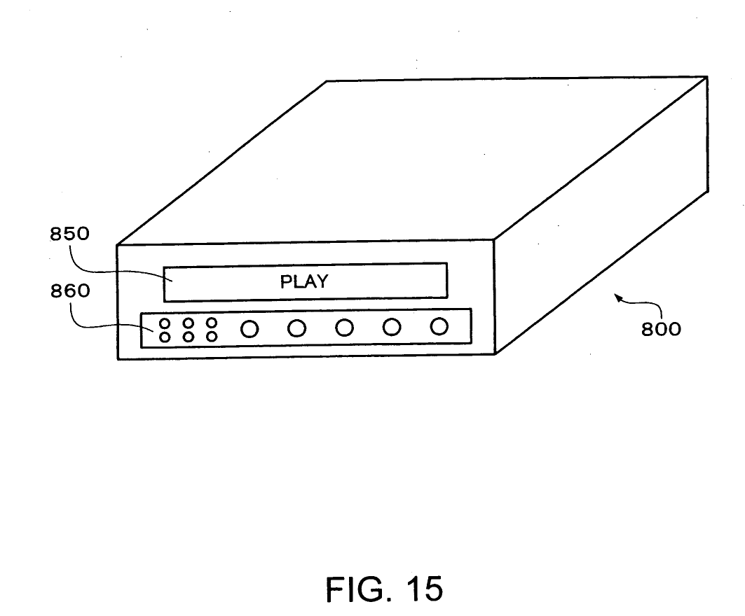

FIG. 14 shows an example of a block diagram of electronic equipment including the data transfer control device shown in FIG. 13. FIG. 14 shows an example of the block diagram of a set-top box, as electronic equipment, having functions as the digital tuner for receiving digital television broadcasting. Further, FIG. 15 shows an example of an outside view of the electronic equipment shown in FIG. 14.

The electronic equipment 800 includes a data transfer control device 600, a digital broadcasting demodulator circuit 820, a physical layer controller 830, a flash ROM 840, an operating section 850, a display section 860, and a MPEG decoder 870. The electronic equipment 800 is connected to a HDD recorder 900 via a bus compliant with the IEEE 1394 or the USB 2.0.

In other words, it can be said that the electronic equipment according to the present embodiment includes the data transfer control device 600 and the flash ROM 300 (external memory device, nonvolatile memory device). It can also be said that the data transfer control device 600 includes the functions of the semiconductor devices 10, 200 in the present embodiment and the functions of the general purpose serial bus interface (e.g., the link controller). In this case, it can be said that, in the data transfer control device 600, the data stored in flash ROM 300 is transferred to the CPURAM 720, and then the CPU macro 700 executes a process (process for protecting the contents) of the data transferred via the general purpose serial bus interface based on the data stored in the CPURAM 720.

Note that, in FIG. 14, a HDD is not provided on the IDE interface, but the stream data is stored in the HDD recorder 900 externally provided.

The digital broadcasting demodulator circuit 820 includes a channel decoder 822, a descrambler 824. The channel decoder 822 extracts the stream data corresponding to one channel from the received wave of the digital broadcasting received by an antenna 910. The descrambler 824 executes a process for canceling the scramble process on the scrambled streaming data. The descrambler 824 is connected to the stream interface 640 shown in FIG. 13.

The physical layer controller 830 is connected to the physical layer interface 620 shown in FIG. 13, and controls the physical layer data transfer compliant with the IEEE 1394 standard to the HDD recorder 900.

The flash ROM 840 is connected to the CPU macro 700 shown in FIG. 13. The flash ROM 840 stores the program to be executed by the CPU macro 700 and the parameters (parameters for contents protection) in an encrypted form.

The MPEG decoder 870 is connected to the stream interface 642, and decodes the stream data from the data transfer control device 600 to output to the digital television 920.

The user can, for example, designate the receiving channel of the digital broadcasting by operating the operating section 850. Further, the present receiving cannel or the like can be confirmed by looking at the information displayed on the display section 860.

The electronic equipment 800 is connected to the HDD recorder 900 via a general purpose (high speed) serial bus such as the IEEE 1394 or the USB 2.0. And, the stream data compliant with the MPEG (Moving Picture Experts Group) standard sent from the digital broadcasting demodulator circuit 820 is stored in the HDD recorder 900 or decoded by the MPEG decoder 870 to output the image on the digital television 920.

When the stream data is recorded in the HDD recorder 900, the stream data (TS packet) compliant with the MPEG standard received by the antenna 910 is written into the HDD recorder 900 via the data transfer control device 600 and the IEEE 1394 (USB 2.0) interface.

Meanwhile, when reproducing the stream data from the HDD recorder 900, the stream data (TS packet, isochronous data) compliant with the MPEG standard is retrieved from the HDD recorder 900 via the bus of the IEEE 1394 interface. And then, the MPEG decoder 870 decodes the retrieved stream data compliant to the MPEG standard. Thus, the image is displayed on the digital television 920.

Note that the electronic equipments applying the present embodiment are not limited to the electronic equipments shown in FIGS. 14 and 15. The present embodiment can be applied to various electronic equipments such as, for example, the HDD recorder, a DVD recorder, a video cassette recorder (with an embedded HDD), an optical disk (DVD) recorder, a digital video camera, a personal computer, or a portable information terminal. Further, although the description assumes that the HDD is not embedded in FIG. 14, the HDD can be embedded. Further, the recording equipment such as a DVD recorder can also be adopted instead of the HDD recorder 900.

According to the configuration shown in FIG. 14, the system development with low cost becomes possible using a general purpose debugger. Moreover, reverse engineering by illegal access from the debugger can be prevented to surely protect licensed highly confidential information.

Note that the present invention is not limited to the embodiment described above, but can be put into practice with various modification within the scope or the spirit of the present invention. For example, terms with broader meaning or the same meaning in the specification or the accompanying drawings can also replaces terms with broader meaning or the same meaning in other descriptions in the specification or the drawings.

Further, although in the above embodiment, the retrieval from the memory device embedded in the semiconductor device is mainly explained, those skilled in the art can similarly realize writing into the memory devices.

Still further, the configurations of the semiconductor devices according to the present embodiments are not limited to the configurations explained in FIGS. 5, 1, and so on, but can be put into practice with various modifications.

Further, in the aspects of the present invention corresponding to the dependent claims, configurations lack a part of elements of the independent claim can also be adopted. Further, a substantial part of one independent claim can be dependent from another independent claim.

1. A semiconductor device comprising:
a central processing unit;
a main memory accessed by the central processing unit;
a security circuit for restricting one of access to the main memory from the central processing unit and access to the main memory from a debugger having an emulation function of the central processing unit and for accessing the main memory as a substitute of the central processing unit; and
a debug-enable signal input terminal to which a debug-enable signal for enabling a debugging function of the debugger is input,
wherein, when the debug-enable signal is inactive,
an access signal from the debugger to the semiconductor device is invalidated, and the security circuit enables the central processing unit to access the main memory,
and, when the debug-enable signal is active,
the access signal from the debugger to the semiconductor device is validated, and the security circuit enables the debugger to access the main memory.

2. The semiconductor device according to claim 1,
wherein, when the debug-enable signal is active,
the access signal from the debugger to the semiconductor device is validated,
after the security circuit disables the access to the main memory, if input data expressed by at least a part of the access signal is predetermined data, the security circuit enables the debugger to access the main memory.

3. The semiconductor device according to claim 2, further comprising:
a secret unique data storing section to which secret unique data is previously set; and
an encryption password generating section for generating encryption password data based on the secret unique data and the input data,
wherein, when password data for verification set previously matches with the encryption password data, the security circuit enables the debugger to access the main memory.

4. The semiconductor device according to claim 3,
wherein the encryption password generating section generates the encryption password data with a one-way encryption process based on the secret unique data and the input data.

5. The semiconductor device according to claim 2,
wherein, when the debugger is disabled to access the main memory, if the semiconductor device is hardware-reset, a succeeding access signal from the debugger is received.

6. The semiconductor device according to claim 1, further comprising:
a decryption key data storing section for storing decryption key data; and
a decryption processing section for executing a decryption process, using the decryption key data, on a source code retrieved from a nonvolatile memory and written into the main memory,
wherein, when the security circuit enables access to the main memory, one of the central processing unit and the debugger retrieves the decrypted source code of the decryption processing section.

7. The semiconductor device according to claim 6, comprising:
a decryption key unique data storing section to which decryption key unique data is previously set,
wherein, the decryption key data is generated based on data for decryption set previously and the decryption key unique data, and then the decryption key data is stored in the decryption key data storing section.

8. The semiconductor device according to claim 1, wherein
when the security circuit enables one of the debugger and the central processing unit to access the main memory, the security circuit releases masking of the access signals output by one of the debugger and the central processing unit,
and when the security circuit disables one of the debugger and the central processing unit to access the main memory, the security circuit masks the access signals output by one of the debugger and the central processing unit.

9. An electronic apparatus comprising:
the semiconductor device according to claim 6; and
a general purpose serial bus interface,
wherein, in the semiconductor device, after the source code stored in the nonvolatile memory is transferred to and stored in the main memory, the central processing unit executes process of data transferred via the general purpose serial bus interface in accordance with the source code stored in the main memory.

10. An access control method of the semiconductor device in which a source code accessed by the central processing unit is stored in the main memory, comprising:
invalidating an access signal from a debugger to the semiconductor device and enabling the central processing unit to access the main memory when a debug-enable signal is inactive, the debug-enable signal enabling a debugging function of the debugger which has an emulation function of the central processing unit and accesses the main memory as a substitute of the central processing unit; and
validating the access signal from the debugger to the semiconductor device and enabling the debugger to access the main memory when the debug-enable signal is active.

11. The access control method of the semiconductor device according to claim 10,
wherein, in the step of enabling the debugger to access the main memory,
after disabling the debugger to access to the main memory, if input data expressed by at least a part of the access signal is predetermined data, the debugger is enabled to access the main memory.

12. The access control method of the semiconductor device according to claim 11, further comprising:
generating encryption password data based on the secret unique data set previously and the input data,
wherein, when password data for verification set previously matches with the encryption password data, the debugger is enabled to access the main memory.

13. The access control method of the semiconductor device according to claim 12,
when the debugger is disabled to access the main memory, if the semiconductor device is hardware-reset, a succeeding access signal from the debugger is received.

14. The semiconductor device according to claim 3,
wherein, when the debugger is disabled to access the main memory, if the semiconductor device is hardware-reset, a succeeding access signal from the debugger is received.

15. The semiconductor device according to claim 4,
wherein, when the debugger is disabled to access the main memory, if the semiconductor device is hardware-reset, a succeeding access signal from the debugger is received.
